(19) United States
(12) Patent Application Publication
(10) Pub. No.: US 2014/0338829 A1
(43) Pub. Date: Nov. 20, 2014

(54) Protective Film Installation Apparatus and Method

(71) Applicants: Robin Peng, Sandy, UT (US); Mark Shulte, Orem, UT (US)

(72) Inventors: Robin Peng, Sandy, UT (US); Mark Shulte, Orem, UT (US)

(73) Assignee: Invisible Gadget Guard, Inc., Salt Lake City, UT (US)

(21) Appl. No.: 14/281,698

(22) Filed: May 19, 2014

Related U.S. Application Data
(60) Provisional application No. 61/825,431, filed on May 20, 2013.

(51) Int. Cl. B32B 37/00; B32B 37/10

(52) U.S. Cl. CPC B32B 37/0046; B32B 37/10; B32B 37/0053; B32B 2037/109; B32B 2307/584; B32B 2307/7265; B32B 2457/202; B32B 2457/208
USPC 156/249; 156/349; 156/580

(57) ABSTRACT

Disclosed is an apparatus for the application of protective films to electronic devices and a method for applying the same. The apparatus utilizes a base shoe and modular framing system that is adaptable for many devices and, when fitted with a device and installed in the shoe, precisely holds the device in a known location relative the shoe. Films are supplied on an application sheet and precisely positioned thereon in a manner such that the application sheet, when positioned on the shoe, holds the film in the exact location needed for quick and precise application of the film. The application sheet is pressed downwards against the device, successively from one edge to another, thereby the film to the device. The shoe features a raised head on a flexible arm, thus raising the film above the level of the device before application and allowing the sheet to be pressed into position.

### CROSS-REFERENCES TO RELATED APPLICATIONS

This application claims priority as a non-provisional perfection of prior filed U.S. provisional application No. 61/825,431, filed May 20, 2013, and incorporates the same by reference herein in its entirety.

### FIELD OF THE INVENTION

The present invention relates to the field of consumer electronics and more particularly relates to an apparatus used to apply protective films to consumer electronics and a method for applying the same.

### BACKGROUND OF THE INVENTION

Consumer electronics have become ubiquitous in our modern society.

They have not only become common, but also serve to connect us together in ways seemingly unimaginable even 50 years ago. Modern consumer electronics, however, suffer many of the same flaws. First among those flaws is that they are fragile, easily scratched or damaged. In particular, many personal electronics now use a display screen, usually an LCD-type screen, in which to display information to the user. Often, these screens are capacitive and are utilized as an input system for the electronic device. These screens are notoriously fragile and easily scratched. Consumer electronic devices tend to also use some form of buttons and have shells which are assembled from multiple pieces, all of which leave space for environmental elements, like water, access to the delicate internal components.

One solution to the above problems is the use of protective films, in particular over the display screen and buttons on the front face of the device. These films form a reasonable barrier that not only prevents access by elemental elements through those areas, but also serve as a barrier to prevent scratches on the most delicate part of the device—the screen. While effective, these films must be positioned over the screen and device perfectly in order to ensure an effective fit. Different films are also needed for different devices. The films tend to use adhesives which can ruin the film if it is applied incorrectly and it is needed to be removed. Even when a film can be salvaged from a misapplication, there is a high time commitment to apply the film correctly. Different shaped films are also needed for different devices. What is needed then, is an apparatus that would cut the time necessary to accurately apply many different films to many different devices while reducing the possibility for error and associated waste.

The present invention is an apparatus for applying protective films to consumer electronic devices, such as mobile phones, music players, hand-held tablets, and any mobile communication device with a flat screen. The present invention represents a departure from the prior art in that the apparatus of the present invention allows for quick, efficient and accurate application of protective films to many different brands and styles of consumer electronic devices.

### SUMMARY OF THE INVENTION

In view of the foregoing disadvantages inherent in the application of protective films to consumer electronics, this invention provides an apparatus that cuts the time necessary to apply such films and also increases the accuracy of applying said films and, thus, reducing waste. As such, the present invention's general purpose is to provide a new and improved protective film application apparatus that is easily adaptable to different devices while easy and efficient to use.

To accomplish these objectives, the apparatus comprises an application frame, or “shoe,” with a modular component that is adaptable for and holds various consumer electronic devices and with positioning posts. The shoe is modular, with different adapter frames capable of being seated within the shoe and of holding different devices. A precisely pre-applied film on a flexible application sheet is positioned over the device as the sheet fits precisely on the posts. Each compatible device has a matching frame and application sheet. The application sheet is angularly suspended over the device as it is held on one end at the foot of the shoe and the other on an elevated, flexible arm. To apply the film, the sheet is then pressed against a device, starting at one end and progressing toward the opposite end, and the film then is precisely applied due to the pre-positioning of the film on the sheeting. The flexible arm bends as the sheet is progressively positioned against the device. The use of this apparatus and associated method, then, features precise pre-positioning of films in a manner to apply them to appropriate consumer electronic devices quickly, efficiently, and with less margin of operator error than the previous method of manually applying the films.

The more important features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of the shoe of the present invention holding a generic mobile phone.

FIG. 2 is a perspective view of the shoe of FIG. 1, with a roller applicator.

FIG. 3 is a side elevation of the shoe of FIG. 2.

FIG. 4 is a perspective view of the shoe of FIG. 2, absent the phone.

FIG. 5 is a top plan view of the shoe of FIG. 4.

FIG. 6 is a front elevation of the shoe of FIG. 4.

FIG. 7 is a side elevation of the shoe of FIG. 4.

FIG. 8 is a bottom plan view of the shoe of FIG. 4.

FIG. 9 is an exploded view of the shoe and generic phone of FIG. 1.

FIG. 10 is an exploded view of a film sheet for the generic phone of FIG. 1.

FIG. 11 is a perspective view of the shoe and application sheet assembled, as application of the film is begun.

FIG. 12 is a side elevation of the shoe and application sheet assembled and in the process of a film being applied to a device.

FIG. 13 is a perspective view of the shoe of FIG. 1 with a second, different style of generic cellular phone.

### DETAILED DESCRIPTION OF THE PREFERRED EMBODIMENT

With reference now to the drawings, the preferred embodiment of the film application apparatus is herein described. It should be noted that the articles “a”, “an”, and “the”, as used in this specification, include plural referents unless the content clearly dictates otherwise.

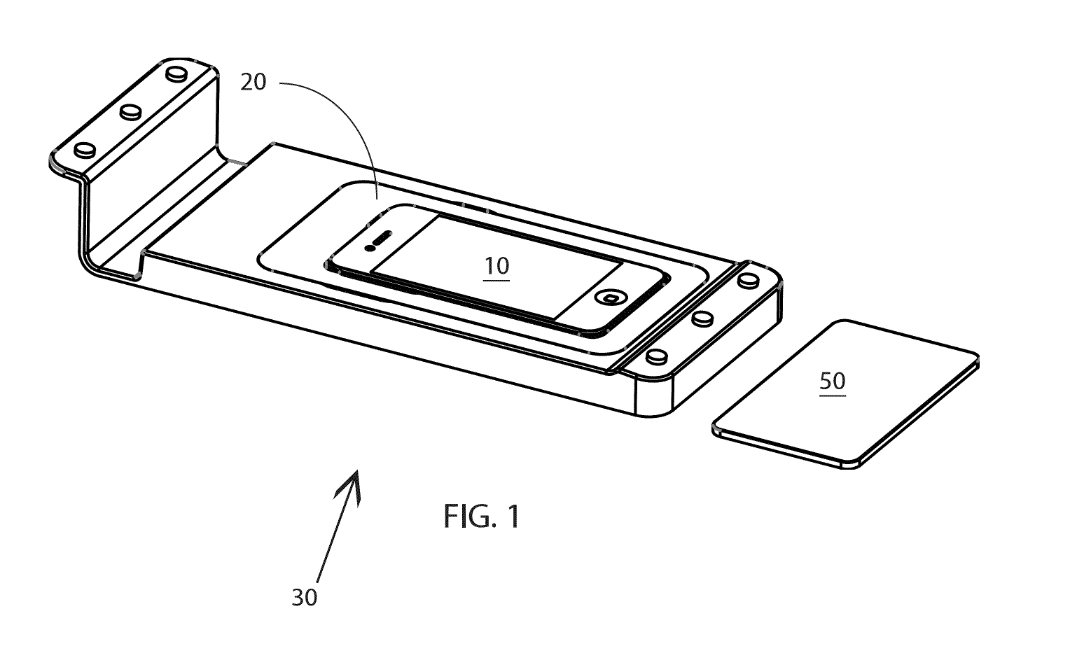

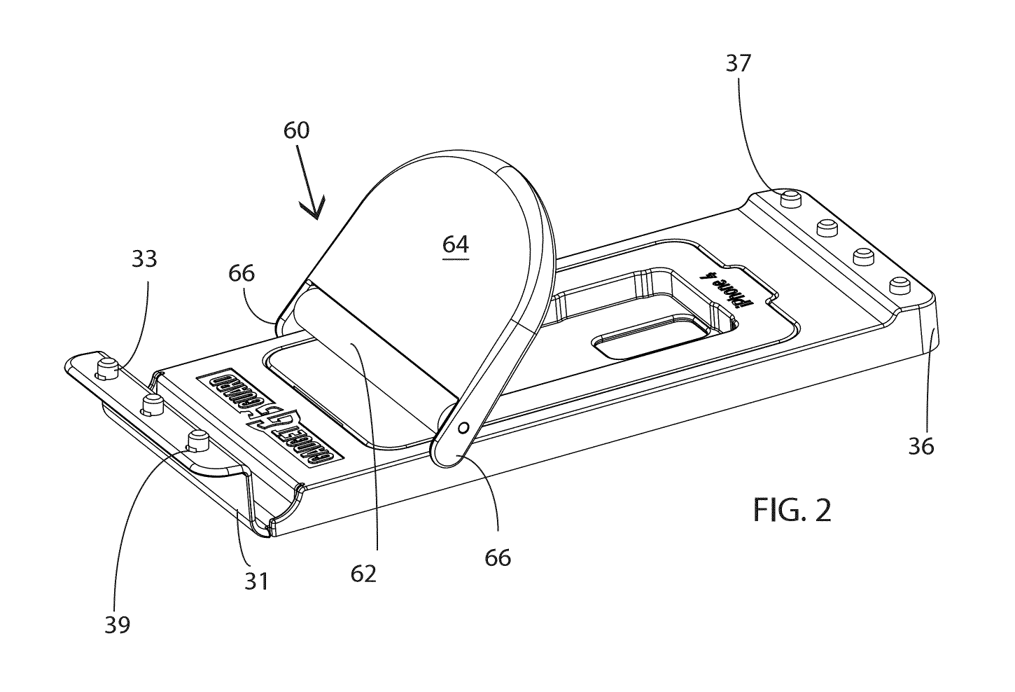

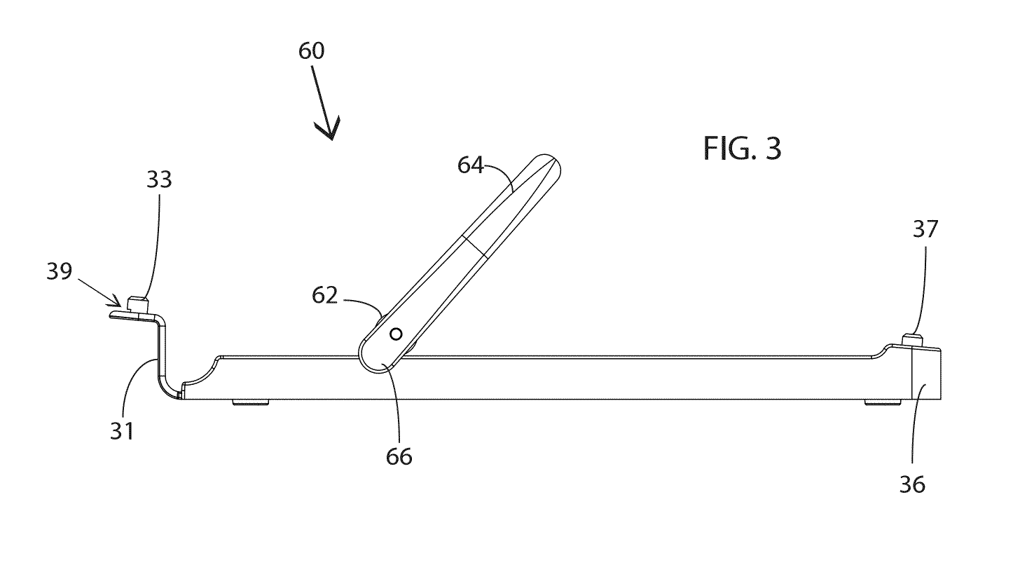

With reference to FIG. 1, the apparatus mainly comprises a shoe 30 and an application sheet 40 with a blade or “squeegee” 50. The shoe 30 contains an adapter frame 20 which is shaped and sized to fit a given consumer electronic device, like the generic phone 10 shown. In a second embodiment (FIGS. 2 and 3) the squeegee 50 may be replaced with roller 60. Roller 60 features a roller 62, which may be made of any suitable material, mounted within handle 64. Handle 64 features two ears 66 located by the roller 62. These ears 66 are positioned such that they slide along the sides of shoe 30, keeping roller 60 orthogonal in relation to the shoe 30. The larger surface area and the rigid orthogonal relation of the roller 60 allows for the film to be applied in a more efficient manner, with less operator error. In a still further alternate embodiment, also shown in FIGS. 2 and 3, guide slots 39 may also be provided to pegs 33 or 37 to aid in securing the application sheet in position.

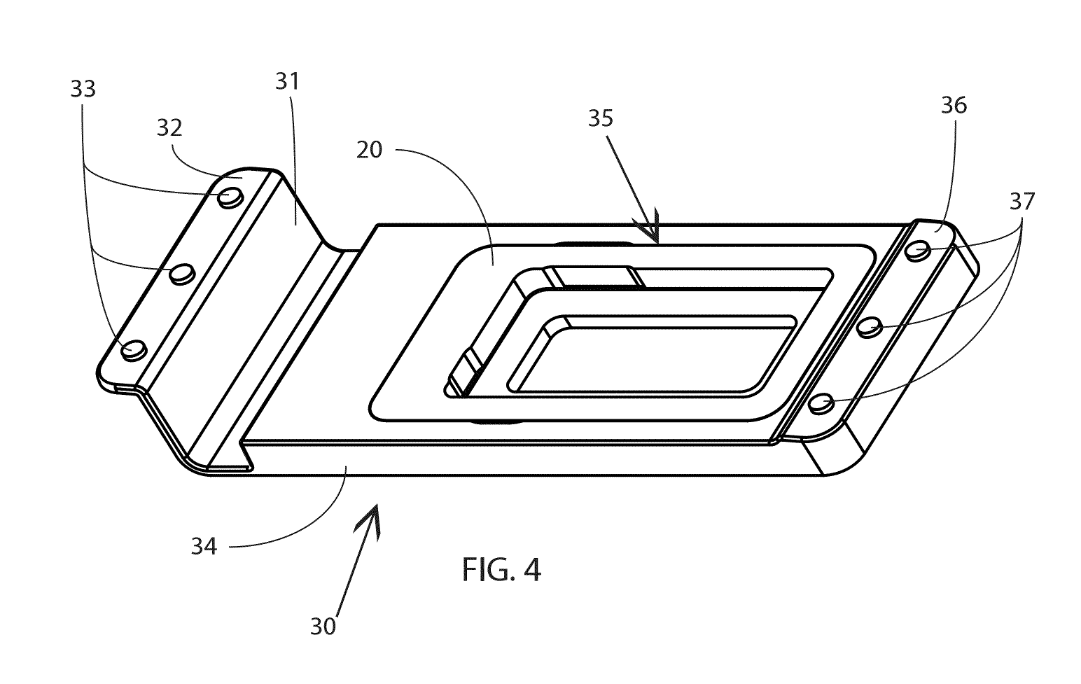

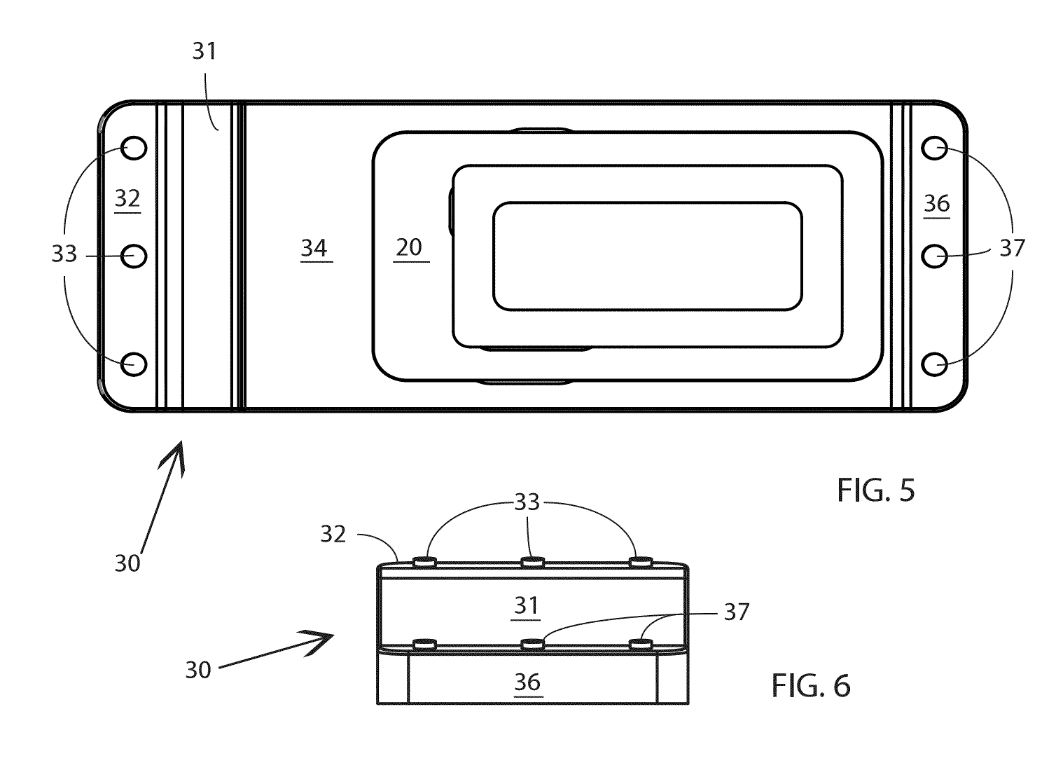

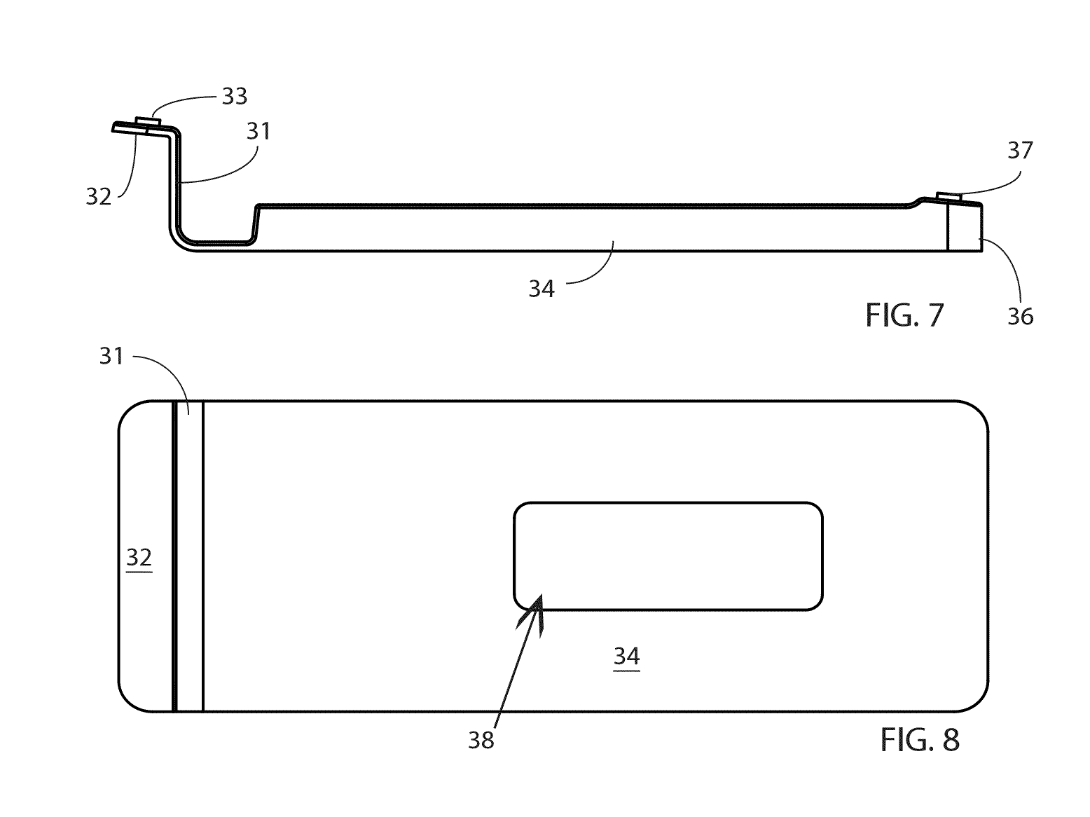

The shoe, as shown in FIGS. 4-9 has a base 34 with a foot 36 and a head 32. The head 32 is raised and resides on a thin arm 31 that somewhat removes it from the main body of the base 34. The thinness of the arm 31 (generally 3-5 mm for ABS plastic) provides a great degree of flexibility to it. The head 32 and foot 36 each have at least one peg 33, 37 which will be used to hold the application sheet 40 (FIG. 11). The shoe 30 may be made of any suitable material, such as metals, plastics, composites or any combination thereof. What is important to the functioning of the apparatus is that the arm 31 must be able to flex in a manner to allow the application sheet 40 contact with the desired device 10 during the application process. As such, many different combinations of materials, including various thicknesses and constructions including hinges and springs, may be utilized to achieve the desired effect and these constructions shall still be considered within the purview of this invention.

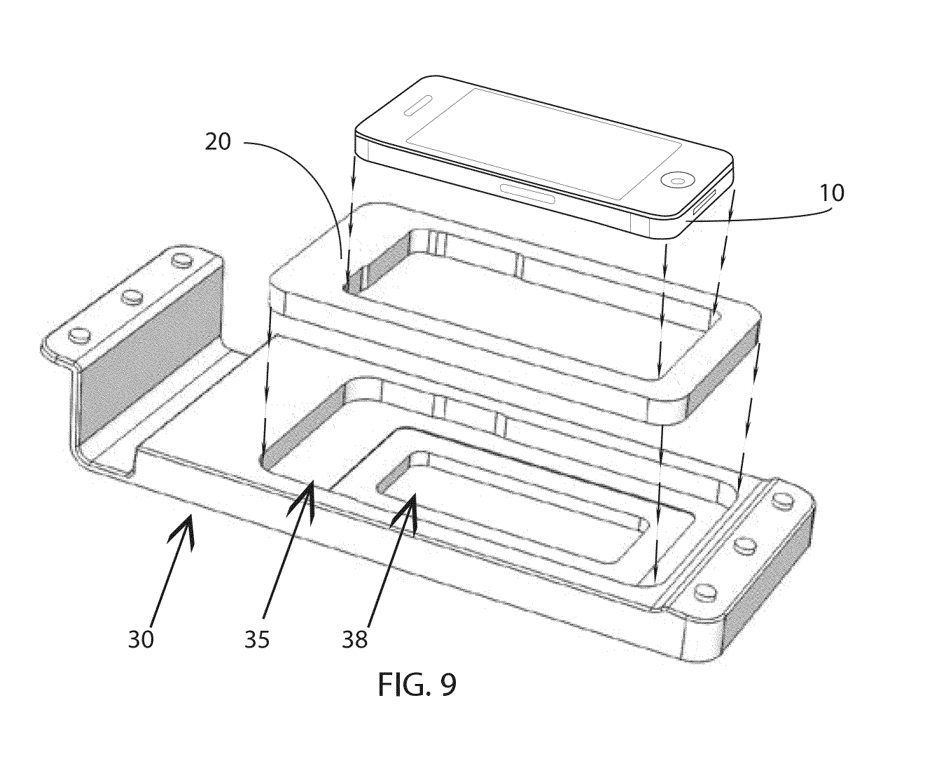

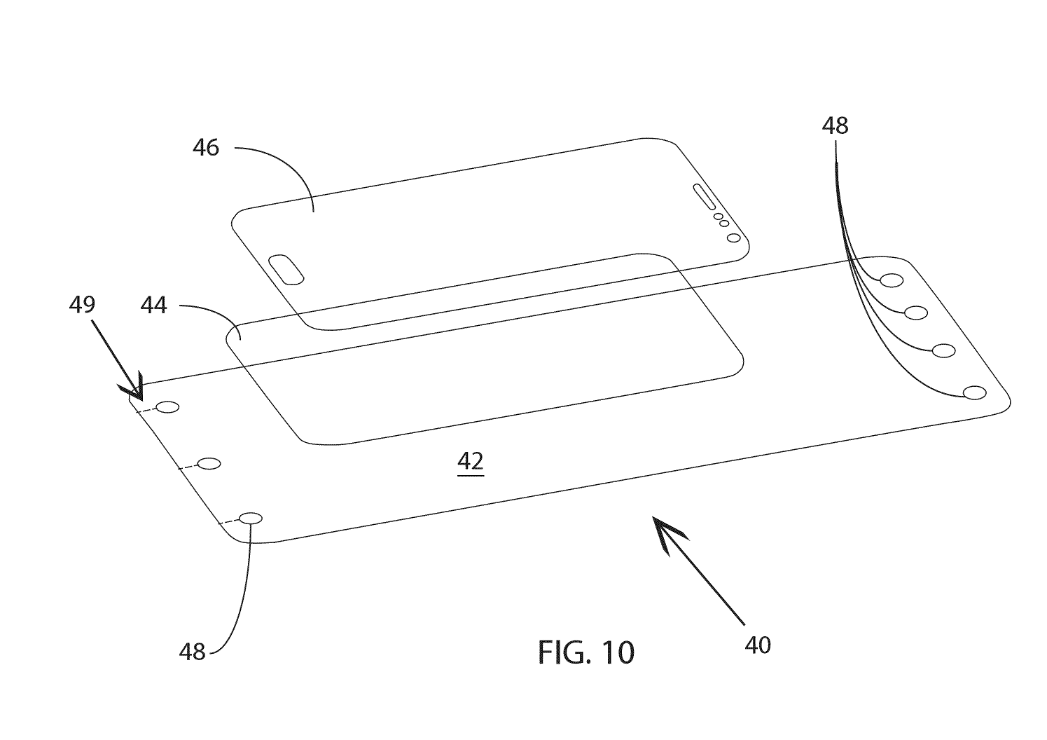

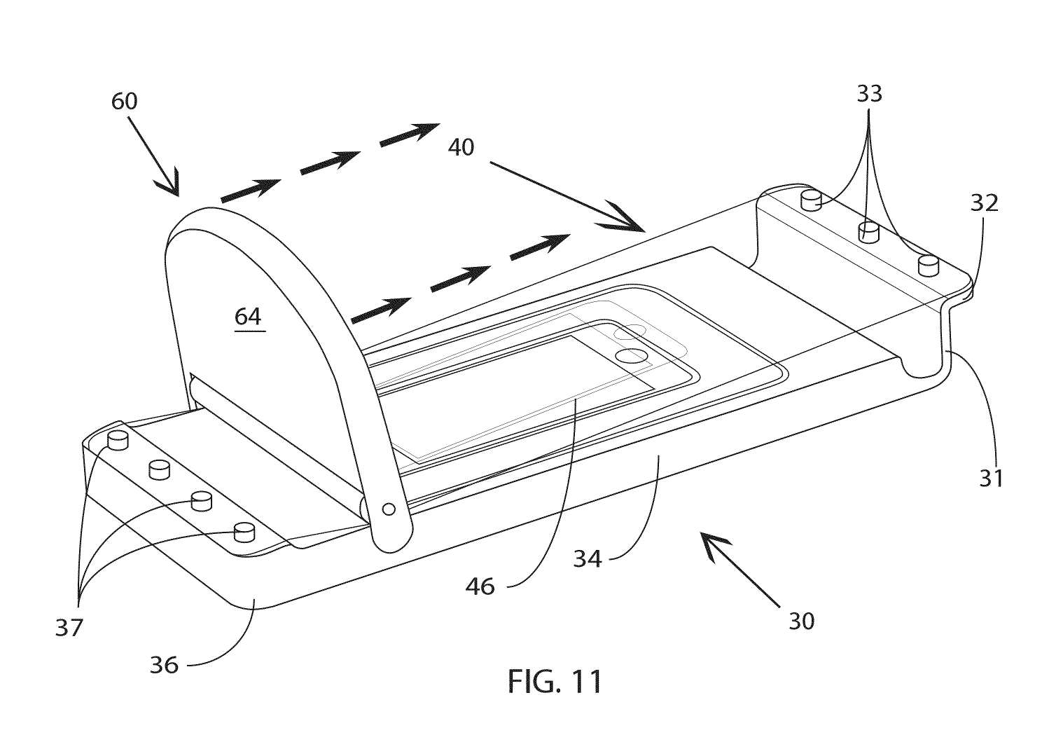

The shoe 30 has a slot 35 (FIG. 9). The slot 35 is generally located towards the foot 36 of the shoe 30 and laterally in the center. The slot 35 is large enough to accommodate a number of targeted consumer electronics within a frame 20. A number of different frames 20, 25 are provided (FIGS. 1, 9 and 12). Each frame 20, 25 is designed to accommodate a given silhouette of a consumer electronic device and have an exterior perimeter that is in conformity with the slot 35. Devices with identical silhouettes may, of course, use the same frame 20 and frames may be constructed for any current or later developed electronic device. To prepare the device 10 for application, it is placed in the frame 20 and the frame 20 is inserted into the slot 35 in the shoe 30. When finished, a through-hole 38 is provided at the bottom of the slot 35 so as to allow the frame 20 and device 10 to be pushed out of the shoe 30. The slot 35 may also conform to a device silhouette and serve as a frame, thus eliminating the need of a separate frame for one style of device.

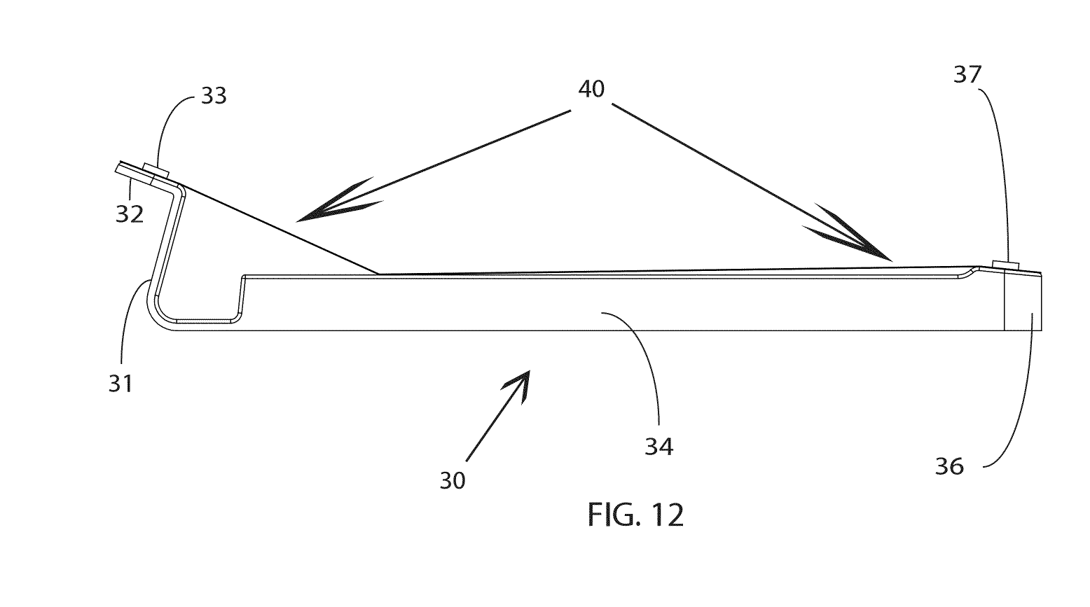

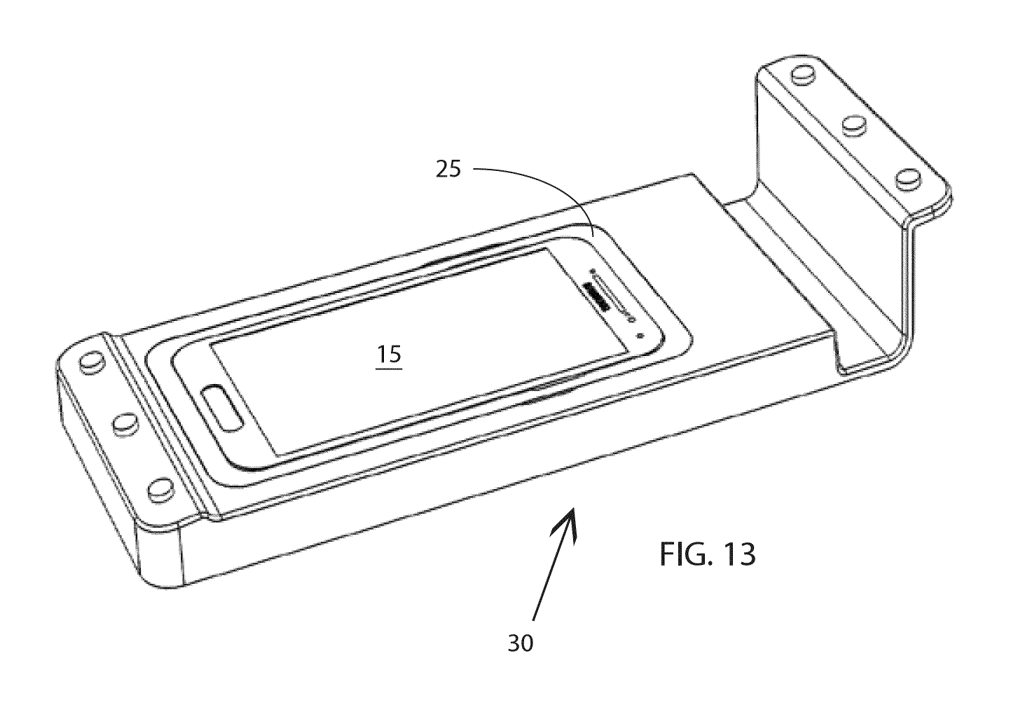

The application sheets 40 are a simple but precise construction, as shown in FIG. 12. A simple backing sheet 42, which is preferred to be made of acetate, is layered with a release liner 44 and the protective film 46 for a given device. The backing sheet 42 is also provided with holes 48 to match the location of the pegs 33, 37 on the head 32 and foot 36. Ideally, perforations 49 are provided to the holes 48 intended to fit over the head pegs 33 so that, when a requisite amount of force is applied to the application sheet 40, the perforations 39 will break and prevent any rebounding effect which might pull the film 46 off of the device 10. These perforations 39 are preferred, though the invention may be practiced without them. The positioning of the film 46 on the sheet 42 is determined by the device type and the location of where it will be on the shoe 30 when application of the film 46 is desired. By utilizing the frame 20 in a uniform system, the precise location of the device may be known and the required pre-positioning of the film 46 determined. Each device 10, then, will have its own frame 20 and application sheet 40, with a pre-cut and precisely positioned film 46.

To apply a film 46 on a device 10, the type of device 10 is determined. Then, a suitable frame 20 and application sheet 40 are selected. The device 10 is positioned in the frame 20 and the frame 20 is then positioned in the shoe 30 (FIG. 9). The application sheet 40 is then positioned on the pegs 33, 37 of the shoe 30 with the film 46 directly over and facing the device 10, as shown in FIG. 12. Initially, the application sheet 40 is suspended above the device 10 by the raised head 32, forming an acute angle with the base 34 of the shoe 30. This allows the process to begin with no accidental contact between the film 46 and the device 10. The roller 60 is then used to press the film 46 against the device 10 by starting at the foot 36 of the shoe 30 and progressing towards the head 32 of the shoe 30. The pressure applied to the application sheet 40 will then flex and draw the arm 31 as roller 60 progresses towards the head 32. This flection is shown in FIG. 12, where the roller has been removed from the view for clarity. The arm 31 provides a limited resistance so that the film 46 is intentionally applied in a controlled, but efficient manner. If the arm 31 does not flex during the process, the backing sheet 42 will distort, thus distorting the position of the film 46 on the backing sheet 42 and causing air bubbles to form when the film 46 is applied to the device 10. Once the roller 60 reaches a point where the entire film is applied, generally the top of the slot, the perforations 39 break, thereby releasing the tension on the film and preventing rebound when the roller 60 is removed. When used, squeegee 50 is preferred to be manufactured from Low Density Polyethylene (LDPE) as this will have a low coefficient of rolling friction when used against the acetate of the backing sheet 42.

Although the present invention has been described with reference to preferred embodiments, numerous modifications and variations can be made and still the result will come within the scope of the invention. No limitation with respect to the specific embodiments disclosed herein is intended or should be inferred.

What is claimed is:

1. An apparatus for the application of protective films to a consumer electronic device, the device having a silhouette defined by its perimeter, the apparatus comprising:
a shoe, the shoe further comprising:
an elongate base, the base having two opposite ends, one being defined as the foot;
a flexible arm extending from the end opposite the foot and terminating in a head positioned above a level of the elongate base;
a plurality of pegs located on both the head and the foot;
a slot located laterally in the center of the elongate base;
at least one frame having an exterior perimeter in conformity with the slot and having an interior perimeter to accommodate the device silhouette, the frame and the shoe, once fitted together with the device securely holding the device at a known position in the shoe; and
an application sheet, the application sheet further comprising:
a backing sheet having a plurality of holes that comport with the pegs of the shoe;
a release liner; and
a protective film for the device, located on the release liner in a manner to comport with the known position of the device in the shoe when the application sheet is installed on the pegs of the shoe with the film facing the device;
wherein, once assembled, the protective film is applied to the device by pressing the application sheet against the device, the arm flexing to accommodate the movement of the application sheet.

2. The apparatus of claim 1, further comprising a plurality of frames, each frame having an interior perimeter to accommodate a different device's silhouette.

3. The apparatus of claim 2, the slot being shaped and sized to accommodate a given second device's silhouette without a frame.

4. The apparatus of claim 1, further comprising a squeegee for pressing the application sheet against the device.

5. The apparatus of claim 1, further comprising a roller for pressing the application sheet against the device.

6. The apparatus of claim 5, the roller further comprising two ears which, when the roller is positioned properly over the shoe, abut the shoe along the elongate base of the shoe.

7. The apparatus of claim 1, the flexible arm extending from the base of the shoe and being made of ABS plastic with a thickness of approximately 3-5 mm.

8. The apparatus of claim 1, the backing sheet being made of acetate.

9. The apparatus of claim 9, further comprising a squeegee for pressing the application sheet against the device, the squeegee being made of LDPE.

10. The apparatus of claim 1, the application sheet being perforated by each hole that is associated with pegs located on the head of the shoe such that when a requisite force is applied to such each hole, the application sheet will fail where it is perforated.

11. A method of applying a protective film to a consumer electronic device, the device having a silhouette defined by its perimeter, the method comprising:
placing the device within a frame having an interior perimeter that comports with the silhouette of the device;
placing the frame, with the device, within a slot in a shoe, the shoe having a head raised on a flexible arm and a foot opposite, both with a plurality of pegs, the frame holding the device in a pre-determined position relative to the shoe;
placing an application sheet holding a pre-positioned film on the pegs, over the device, the position of the film being selected to comport with the position of the device relative the shoe; and
pressing the application sheet against the device in a manner that gradually increases contact of the film with the device and leaves the film on the device when the application sheet is removed.

12. The method of claim 11, the frame being selected from a plurality of frames, each frame having a different interior perimeter that accommodates a silhouette of a different device and the application sheet is selected from a plurality of application sheets, each with different shapes and positions of films to comport with different devices.

13. The method of claim 12, the frame being the slot in the shoe.

14. The method of claim 13, the application sheet being pressed against the device by a thin squeegee, working the application sheet progressively against the device from one end to an opposite end.

15. The method of claim 13, the application sheet being pressed against the device by a roller, working the application sheet progressively against the device from one end to an opposite end.

16. The method of claim 12, the application sheet being pressed against the device by a thin squeegee, working the application sheet progressively against the device from one end to an opposite end.

17. The method of claim 12, the application sheet being pressed against the device by a roller, working the application sheet progressively against the device from one end to an opposite end.

18. The method of claim 11, the application sheet being pressed against the device by a thin squeegee, working the application sheet progressively against the device from one end to an opposite end.

19. The method of claim 11, the application sheet being pressed against the device by a roller, working the application sheet progressively against the device from one end to an opposite end.

20. The method of claim 11, the application sheet breaking at provided perforations at some point after the film is entirely applied to the device.
